(19) United States
(12) Patent Application Publication
(10) Pub. No.: US 2019/0088406 A1
(43) Pub. Date: Mar. 21, 2019

(54) THIN FILM CHIP ELECTRIC COMPONENT

(71) Applicant: SAMSUNG ELECTRO-MECHANICS CO., LTD., Suwon-si (KR)

(72) Inventors: Young Ji KIM, Suwon-si (KR); Jin Ho KU, Suwon-si (KR); Hyo Chan OH, Suwon-si (KR)

(21) Appl. No.: 15/981,622

(22) Filed: May 16, 2018

(30) Foreign Application Priority Data
Sep. 20, 2017 (KR) 10-2017-0121295

(51) Int. Cl. H01F 27/29; H01F 27/28; H01F 27/32; H01F 27/24

(52) U.S. Cl. CPC H01F 27/29; H01F 27/24; H01F 27/327; H01F 27/2804

(57) ABSTRACT

A thin film chip electronic component, and more particularly, a thin film power inductor includes a body including a support member including a through hole, an inner coil supported by the support member in a thickness direction, and a magnetic material sealing the support member and the inner coil; and a plurality of external electrodes disposed on an external surface of the body. The inner coil includes a coil body and first and second end portions. Each of the first and second end portions includes a connection portion extending from the coil body and a contact portion extending from the connection portion, the connection portion being a portion that changes a winding direction of the coil body, and the contact portion is directly connected to one of the plurality of external electrodes.

### CROSS-REFERENCE TO RELATED APPLICATION(S)

This application is based on and claims the benefit of priority to Korean Patent Application No. 10-2017-0121295 filed on Sep. 20, 2017 in the Korean Intellectual Property Office, the entire disclosure of which is incorporated herein by reference.

### TECHNICAL FIELD

The present disclosure relates to a thin film chip electronic component, and more particularly, to a thin film power inductor.

### BACKGROUND

Recently, in order to implement high performance and high functionality in portable devices, the number of power inductors employed therein has been increasing in order to increase the operation speed of an AP or the like and to stabilize a current by increasing the current.

A thin film power inductor includes a magnetic body including a coil influencing the performance of an inductor and an external electrode for mounting on a substrate. In general, the external electrode surrounds a body having a rectangular parallelepiped shape, and is in physical contact with a lead portion of the coil in the magnetic body.

Therefore, it is advantageous to increase the contact cross-sectional area for enhancing a contact between the lead portion of the coil and the external electrode. As described above, in order to increase the contact cross-sectional area, it is necessary to increase a line width of the lead portion of the coil. However, when the line width of the lead portion of the coil is increased, the current density may be increased when plating of the lead portion of the coil is grown, thereby causing overgrowth. As a result, a problem of a coil plating deviation may arise in the lead portion of the coil.

In order to increase the contact area between the lead portion of the coil and the external electrode while solving the problem of the coil plating deviation, a slit maybe formed in the center of the lead portion of the coil as shown in FIG. 1. However, in this case, impurities may remain inside the slit or a problem in which a DFR is incompletely stripped when the DFR is stripped to form a slit structure may arise.

### SUMMARY

An aspect of the present disclosure may provide a thin film chip electronic component to secure a sufficient contact area between a lead portion of an inner coil and an external electrode while preventing an over-plating of the lead portion of the inner coil.

According to an aspect of the present disclosure, a thin film chip electronic component may include a body having first and second end surfaces facing each other in a length direction and including a support member including a through hole, an inner coil supported by the support member in a thickness direction, and a magnetic material sealing the support member and the inner coil; and a plurality of external electrodes disposed on an external surface of the body, wherein the inner coil includes a coil body and first and second end portions, the first and second end portions being exposed to the first and second end surfaces, respectively, and electrically connected to the plurality of external electrodes, each of the first and second end portions includes a connection portion extending from the coil body and a contact portion extending from the connection portion in a direction different from a winding direction of the coil body, and the contact portion is directly connected to one of the plurality of external electrodes, a maximum width Wmax of the contact portion is equal to or greater than 0.8 times and equal to or smaller than 1.2 times a width Wo of an outermost coil pattern of the coil body in contact with the connection portion, and a corner edge at which an upper surface of the contact portion and inner surfaces of the plurality of external electrodes contact each other is composed of one line segment in a width direction perpendicular to the length and thickness directions.

According to another aspect of the present disclosure, a thin film chip electronic component may include a body having first and second end surfaces facing each other in a length direction and including a support member including a through hole, an inner coil supported by the support member in a thickness direction, and a magnetic material sealing the support member and the inner coil; and a plurality of external electrodes disposed on an external surface of the body, wherein the inner coil includes a coil body and first and second end portions, the first and second end portions being exposed to the first and second end surfaces, respectively, and electrically connected to the plurality of external electrodes, each of the first and second end portions includes a connection portion extending from the coil body and a contact portion extending from the connection portion in a direction different from a winding direction of the coil body, and the contact portion is directly connected to one of the plurality of external electrodes, and the contact portion extends to at least one side of the body in a width direction perpendicular to the length and thickness directions, the contact portion extending in a straight line without having an opening in the center thereof.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 is a schematic perspective view of a thin film chip electronic component according to an exemplary embodiment in the present disclosure;

FIG. 2 is a plan view of an inner coil viewed from an upper surface of the thin film chip electronic component of FIG. 1; and

FIG. 3 is a plan view according to a modification of the inner coil of FIG. 2.

FIG. 4 is a plan view of an inner coil viewed from a lower surface of the thin film chip electronic component of FIG. 1;

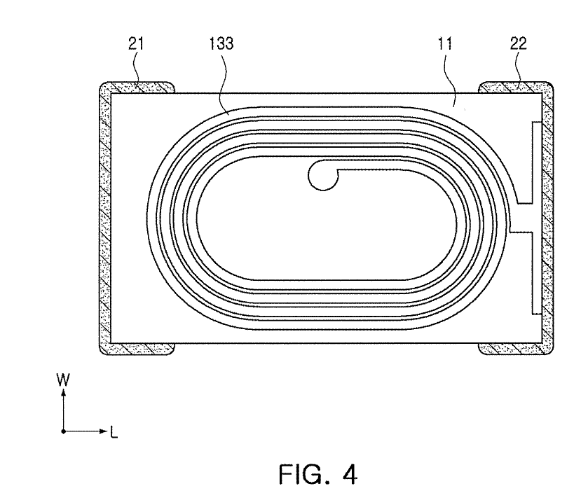

### DETAILED DESCRIPTION

Hereinafter, exemplary embodiments in the present disclosure will now be described in detail with reference to the accompanying drawings.

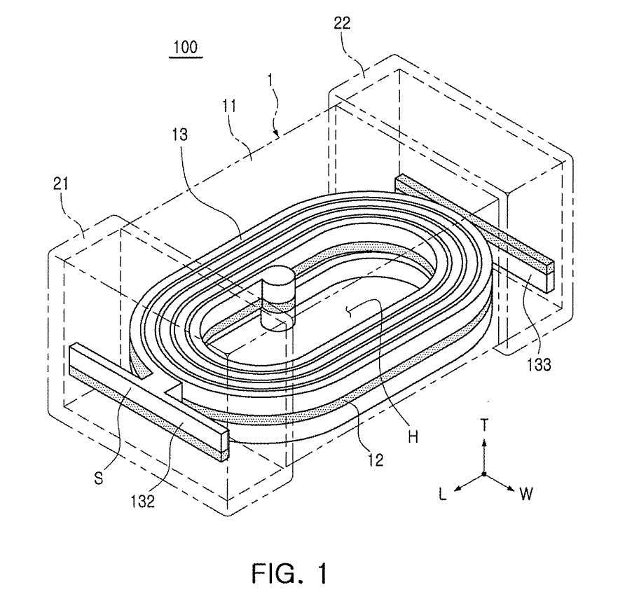

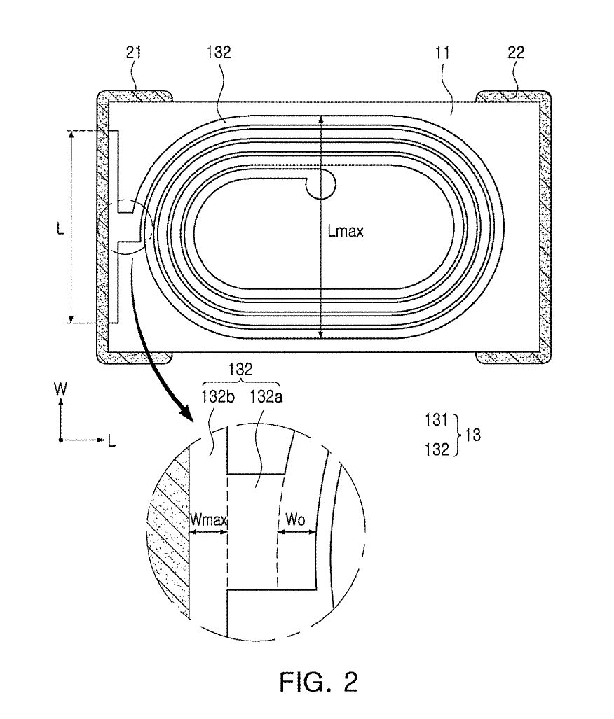

FIG. 1 is a schematic perspective view of a thin film chip electronic component 100 according to an exemplary embodiment in the present disclosure. FIG. 2 is a plan view of an inner coil viewed from an upper surface of the thin film chip electronic component 100 of FIG. 1.

Referring to FIGS. 1 and 2, the thin film chip electronic component 100 is a substantially thin film power inductor. The thin film chip electronic component 100 includes a body 1 and external electrodes 21 and 22 disposed on an external surface of the body 1.

The body 1 exhibits an appearance of a coil component and may include an upper surface and a lower surface facing each other in a thickness direction T, a first end surface and a second end surface facing each other in a length direction L, and a first side surface and a second side surface facing each other in a width direction W to have a substantially hexahedral shape, but is not limited thereto.

The body 1 includes a magnetic material 11 and may be formed, for example, filled with ferrite or a metal-based soft magnetic material. The ferrite may include a known ferrite such as Mn—Zn ferrite, Ni—Zn ferrite, Ni—Zn—Cu ferrite, Mn—Mg ferrite, Ba ferrite or Li ferrite, etc. The metal-based soft magnetic material may be an alloy including at least one selected from the group consisting of Fe, Si, Cr, Al and Ni, and may include, for example, Fe—Si—B—Cr based amorphous metal particles but is not limited thereto. The metal-based soft magnetic material may have a particle diameter of 0.1 to 20 μm and may be dispersed on a polymer such as epoxy resin or polyimide.

The body 1 further includes an inner coil 13 sealed by the magnetic material 11 and a support member 12 for supporting the inner coil 13.

First, the support member 12 functions to easily form the inner coil 13 and suitably support the inner coil 13. The support member 12 is preferably configured in the form of a thin plate having an overall insulating property, and may be, for example, a CCL (Copper Clad Laminate) ora PCB, but is not limited thereto. The support member 12 may be a thin plate capable of exhibiting the function. A thickness of the support member 12 (in this case, meaning the maximum thickness of the support member 12) is sufficient to be able to support the inner coil 13, and may be, for example, 20 μm to 80 μm, but is not limited thereto.

A through hole H is formed at the center of the support member 12 and is filled with a magnetic material 11. The through hole H may improve the permeability of the thin film power inductor.

Next, the inner coil 13 supported by the support member 12 includes a coil body 131 having a spiral shape as a whole and a first end portion 132 and a second end portion 133 respectively connected to the first and second external electrodes 21 and 22.

The overall shape of an outer boundary surface of the coil body 131 may be an elliptical shape or a rectangular shape, but is not particularly limited.

The first end portion 132 and the second end portion 133 of the inner coil 13 may be respectively exposed to the first end surface and the second end surface of the body 1.

The first end portion 132 includes a connection portion 132a directly connected to the coil body 131 and a contact portion 132b connected to the connection portion 132a and directly connected to the first external electrode. Similarly, the second end portion 133 includes a connection portion (not shown) directly connected to the coil body 131 and a contact portion (not shown) connected to the connection portion and directly connected to the second external electrode. Descriptions of the connection portion 132a and the contact portion 132b of the first end portion 132 may be substantially applied to descriptions of the connection portion and the contact portion of the second end portion 133, and thus a detailed description of the second end portion 133 will be omitted for convenience of explanation.

The connection portion 132a of the first end portion 132 may be defined as a part of the inner coil 13 at a point that starts changing a direction in which the outermost coil pattern of the coil body 131 is wound so as to expose the inner coil 13 to the first end surface of the body 1. A specific shape of the connection portion 132a is not limited, but at least one corner of the cross-section may be formed to be perpendicular to the first end surface of the body 1. The connection portion 132a does not physically contact the first external electrode substantially, is a portion that changes a direction in which the inner coil 13 is wound so as to be exposed to the external surface of the body 1, and there is no restriction on a specific shape of the connection portion 132a.

The first end portion 132 further includes the contact portion 132b connected to both the connection portion 132a and the first external electrode in addition to the connection portion 132a.

Meanwhile, although the connection portion 132a and the contact portion 132b of the first end portion 132 are described as separate components, this is for convenience of description, and the connection portion 132a and the contact portion 132b are integrally formed substantially and formed simultaneously through the same plating process.

The upper surface of the contact portion 132b and an inner surface of the first external electrode which contact each other form a corner edge S. In this case, the corner edge S is composed of one line segment. That the corner edge S is composed of one line segment means that the contact portion 132b does not include a slit. In a case where the contact portion 132b includes the slit, the corner edge S between the upper surface of the contact portion 132b and the inner surface of the first external electrode is composed of two line segments spaced apart from each other in a width direction of the body 1. In the present disclosure, since the corner edge S where the upper surface of the contact portion 132b and the inner surface of the first external electrode contact each other is formed by only one line segment, it is possible to prevent a problem in advance that a DFR un-stripping failure occurs in the contact portion 132b.

On the other hand, a maximum width Wmax of the contact portion 132b has a level of 0.8 to 1.2 with respect to a width Wo of the outermost coil pattern of the coil body 131 contacting with the connection portion 132a. In a case where the maximum width Wmax is smaller than 0.8 times the width Wo of the outermost coil pattern of the coil body 131 that contacts the connection portion 132a, there is a risk that the mechanical strength of the contact portion 132b may not be sufficiently secured and the contact portion 132b may be detached from the first external electrode. On the other hand, in a case where the maximum width Wmax is greater than 1.2 times the width Wo of the outermost coil pattern of the coil body 131 in contact with the connection portion 132a, it is problematic that the contact portion 132b is overplated. In a case where the width of the pattern is large, the current density is increased substantially at the corresponding pattern part, which increases the possibility of occurrence of over-plating. Therefore, it is most preferable that the maximum width Wmax of the contact portion 132b is substantially equal to the width of the coil pattern included in the coil body 131.

The contact portion 132b may be arranged parallel to the width direction of the body 1. The length L distance in the width direction of the body 1 is not particularly limited. However, in order to secure a sufficient contact area with the first external electrode, it is preferable that the length L is equal to or larger than ½ of the maximum distance Lmax spaced between the outermost coil patterns of the coil body 131 with respect to the width direction of the body 1.

In this case, the contact portion 132b may extend from the connection portion 132a to both sides along the width direction of the body 1. This is an advantageous structure in which the contact portion 132b may sufficiently secure the length L distance in the width direction of the body 1. Preferably, when the contact portion 132b extends along the width direction of the body 1, its central point is suitably connected to the connection portion 132a but is not limited thereto. The contact portion 132b may be arranged asymmetrically from the connection portion 132a along the width direction of the body 1.

In a case of including the first end portion 132 including the contact portion 132b and the extension portion, the contact property between the inner coil 13 and the first external electrode may be sufficiently ensured, and it is possible to in advance prevent occurrence of over-plating that may be problematic when a line width is usually increased to secure the contact property.

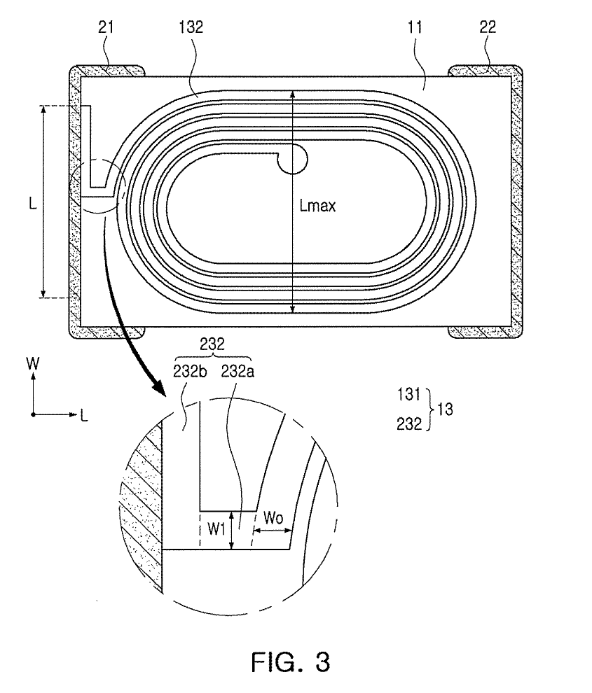

Next, FIG. 3 is a plan view according to a modification of an inner coil of FIG. 2. A thin film chip electronic component 200 of FIG. 3 and the thin film chip electronic component 100 of FIG. 2 are merely different in lengths of the contact portions 132b and 133b and a position relationship between the contact portion and the connection portion but include substantially the same configuration. Therefore, for convenience of description, the overlapping description between the thin film chip electronic component 100 of FIG. 2 and the thin film chip electronic component 200 of FIG. 3 is omitted, and the same reference numerals are used for overlapping reference numerals.

Referring to FIG. 3, a first end portion 232 of the inner coil 13 includes a connection portion 232a and a contact portion 232b. Although the connection portion 232a is substantially the same as the connection potion 132a of the thin film chip electronic component 100 described with reference to FIGS. 1 and 2, the connection portion 232a may have preferably a narrower line width than the connection portion 132a and may have preferably a line width W1 that is substantially the same as the width Wo of the outermost coil pattern of the coil body 131 contacting with the connection portion 232a. The reason why the connection portion 232a has the thinner line width than the connection portion 132a of the thin film chip electronic component 100 of FIGS. 1 and 2 is that it is preferable to adjust a balance of the current density so as not to cause a plating deviation according to a size (a line width, a length, etc.) of the contact portion 232b directly connected to the connection portion 232a. Specifically, since the contact portion 232b directly connected to the connection portion 232a may extend only from one end of the connection portion 232a with respect to a width direction of a body, compared to the contact portion 132b extending from both ends of the connection portion 132a, the contact portion 232b has a shorter length even when the contact portion 232b has substantially the same line width as the contact portion 132b. Therefore, by thinning the line width of the connection portion 232a directly connected to the relatively short contact portion 232b, the overall plating thickness of the inner coil 13 may be more uniformly controlled.

On the other hand, although not specifically shown, a second end portion is disposed at a position opposite to the first end portion 232 with respect to a length direction of the body. The second end portion connects a second external electrode and the inner coil, and is preferably configured to have a point-symmetrical position relationship with respect to a core center of the coil. Specifically, the contact portion in the second end portion and the contact portion in the first end portion are configured to have the point-symmetrical position relationship with respect to the core center of the coil. In this case, when a magnetic material is filled in upper and lower surfaces of the inner coil, the first end portion and the second end portion apply a complementary force to each other to prevent twisting of the inner coil.

Except for the above description, the overlapping description of the features of the thin film chip electronic component according to an example in the present disclosure described above will be omitted here.

As set forth above, the thin film chip electronic component according to an exemplary embodiment in the present disclosure may reduce a plating deviation between coil patterns constituting an inner coil and secure a contact area between a coil lead portion and an external electrode.

While exemplary embodiments have been shown and described above, it will be apparent to those skilled in the art that modifications and variations could be made without departing from the scope in the present disclosure as defined by the appended claims.

What is claimed is:

1. A thin film chip electronic component comprising:
a body having first and second end surfaces facing each other in a length direction and including a support member including a through hole, an inner coil supported by the support member in a thickness direction, and a magnetic material sealing the support member and the inner coil; and
a plurality of external electrodes disposed on an external surface of the body,
wherein the inner coil includes a coil body and first and second end portions, the first and second end portions being exposed to the first and second end surfaces, respectively, and electrically connected to the plurality of external electrodes,
each of the first and second end portions includes a connection portion extending from the coil body and a contact portion extending from the connection portion in a direction different from a winding direction of the coil body, and the contact portion is directly connected to one of the plurality of external electrodes,
a maximum width Wmax of the contact portion is equal to or greater than 0.8 times and equal to or smaller than 1.2 times a width Wo of an outermost coil pattern of the coil body in contact with the connection portion, and
a corner edge at which an upper surface of the contact portion and inner surfaces of the plurality of external electrodes contact with each other is composed of one line segment in a width direction perpendicular to the length and thickness directions.

2. The thin film chip electronic component of claim 1, wherein the contact portion is perpendicular to the connection portion.

3. The thin film chip electronic component of claim 1, wherein a cross-sectional shape of the contact portion is a rectangular shape.

4. The thin film chip electronic component of claim 1, wherein a length of the contact portion extending in the width direction of the body is equal to or more than ½ of a maximum distance between outermost coil patterns of the coil body along the width direction of the body.

5. The thin film chip electronic component of claim 1, wherein the contact portion extends to two opposing sides of the body in the width direction with respect to the connection portion.

6. The thin film chip electronic component of claim 5, wherein a line width of the connection portion in the width direction is greater than the width Wo of the outermost coil pattern of the coil body that is in contact with the connection portion.

7. The thin film chip electronic component of claim 1, wherein the contact portion is connected to one end of the connection portion and extends only in one direction with respect to the width direction of the body.

8. The thin film chip electronic component of claim 7, wherein a direction in which the contact portion of the first end portion extends is opposite to a direction in which the contact portion of the second end portion extends with respect to the width direction of the body.

9. The thin film chip electronic component of claim 7, wherein a line width of the connection portion is equal to the width of the outermost coil pattern of the coil body that is in contact with the connection portion.

10. The thin film chip electronic component of claim 1, wherein the plurality of external electrodes include first and second external electrodes, the first external electrode is physically connected to the first end portion, and the second external electrode is physically connected to the second end portion.

11. A thin film chip electronic component comprising:
a body having first and second end surfaces facing each other in a length direction and including a support member including a through hole, an inner coil supported by the support member in a thickness direction, and a magnetic material sealing the support member and the inner coil; and
a plurality of external electrodes disposed on an external surface of the body,
wherein the inner coil includes a coil body and first and second end portions, the first and second end portions being exposed to the first and second end surfaces, respectively, and electrically connected to the plurality of external electrodes,
each of the first and second end portions includes a connection portion extending from the coil body and a contact portion extending from the connection portion in a direction different from a winding direction of the coil body, and the contact portion is directly connected to one of the plurality of external electrodes, and
the contact portion extends to at least one side of the body in a width direction perpendicular to the length and thickness directions, the contact portion extending in a straight line without having an opening in the center thereof.

12. The thin film chip electronic component of claim 11, wherein a maximum width Wmax of the contact portion is equal to or greater than 0.8 times and equal to or smaller than 1.2 times a width Wo of an outermost coil pattern of the coil body in contact with the connection portion.

13. The thin film chip electronic component of claim 11, wherein the contact portion extends only in one direction with respect to the width direction of the body.

14. The thin film chip electronic component of claim 11, wherein the contact portion extends to two opposing sides of the body in the width direction with respect to the connection portion.
